(19) United States
(12) Patent Application Publication
(10) Pub. No.: US 2006/0034220 A1
(43) Pub. Date: Feb. 16, 2006

(54) Digital wireless communication device

(76) Inventor: Eiji Shinshou, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/916,809

(22) Filed: Aug. 12, 2004

(51) Int. Cl. H04Q 7/00

(52) U.S. Cl. 370/329; 370/437

(57) ABSTRACT

It is an object of the present invention to implement stabilized wireless communications by establishing suitable channel switching conditions for a digital wireless communication device that performs wireless communications with a single base station. In order to achieve this object, the cordless phone child device according to the present invention comprises a wireless unit that sends and receives a wireless signal to and from the base station; a frame extractor that extracts frames from the wireless signal; a frame error rate computation unit that computes the frame error rate; a counter that counts the number of frames in which a frame error occurs and for which the received signal intensity exceeds a predetermined threshold value; and a channel switching judgment unit that judges that the channel switching conditions have been fulfilled when the frame error rate computed by the frame error rate computation unit is equal to or more than a predetermined threshold value and the number of frames counted by the counter is equal to or more than a predetermined threshold value.

### BACKGROUND OF THE INVENTION

1. Field of the Invention

The present invention relates to a channel switching technology for a digital wireless communication device that performs wireless communications with a single base station.

2. Description of the Related Art

A PHS (Personal Handy phone System) is a system for developing digital cordless phones in which wireless interfaces between a PHS terminal that corresponds to a child device and a base station that corresponds to a parent device are standardized as the ‘Second-generation cordless phone system standard (RCR STD-28)'. As a countermeasure for interference during a call, this standard provides regulation such that the quality of the wireless line is measured by means of the FER (Frame Error Rate) and channel switching or other processing is then performed according to the degree of quality. Further, regulation is such that channel switching is executed if the RSSI (Received Signal Strength Indicator) level is equal to or less than a threshold value in a weak electrical field environment. On the other hand, in the case of a cordless phone that adopts the 2.4-GHz band DSSS (Direct Sequence Spread Spectrum) communication method, radio wave interference is sometimes received from a variety of interference sources such as a wireless LAN, microwave oven, and so forth that utilize the ISM (Industry Science Medical) band. Therefore, the channel must be suitably switched. As an example of related technology, Japanese Patent Application Laid Open No. 2000-92559 proposes a technology in which a base station performs channel switching because a mobile wireless terminal communicates used channel reception state information to the base station.

However, in the case of a cordless phone, there is normally a single base station (parent device), and therefore channel switching renders reconnection impossible in a weak electrical field and might bring about deterioration in the conditions. Hence, channel switching has not been possible under the conditions of STD-28.

### SUMMARY OF THE INVENTION

The present invention is accordingly tasked with implementing stabilized wireless communications by establishing suitable channel switching conditions for a digital wireless communication device that performs wireless communications with a single base station.

In order to achieve this object, the digital wireless communication device according to the present invention is a digital wireless communication device that performs wireless communications with a single base station and performs channel switching when pre-established channel switching conditions are fulfilled, comprising: a wireless unit that sends and receives a wireless signal to and from the base station; a frame extractor that extracts frames from the wireless signal; a frame error rate computation unit that computes the frame error rate of the frames extracted by the frame extractor; a counter that counts the number of frames in which a frame error occurs among the frames extracted by the frame extractor and for which the received signal intensity exceeds a predetermined threshold value; and a channel switching judgment unit that judges that the channel switching conditions have been fulfilled when the frame error rate computed by the frame error rate computation unit is equal to or more than a predetermined threshold value and the number of frames counted by the counter is equal to or more than a predetermined threshold value. When there is a single base station, channel switching is not executed merely because the wireless environment is a weak electric field. Suitable channel switching can be performed by making a distinction as to whether the cause of a frame error generated under the condition that the received signal intensity should be equal to or more than a predetermined threshold value is due to interfering waves or generated unexpectedly as in the case of phasing, frequency hopping, or the like.

The digital wireless communication device preferably further comprises a control unit that, when the channel switching conditions are fulfilled, switches the channel in sync with the base station on the basis of channel switching information that is shared beforehand with the base station. It is therefore possible to perform muteless channel switching.

The digital wireless communication device desirably further comprises a measurement unit that measures the received signal intensity in a channel that is not being used for a connection with the base station among a plurality of channels, wherein the control unit sets reconnection channel priority levels in order starting with the highest priority level for the lowest received signal intensity measured by the measurement unit. Because the existence of interfering waves can be distinguished by means of the received signal intensity, it is possible to raise the call quality by setting reconnection channel priority levels in order starting with the highest priority level for the lowest received signal intensity.

### BRIEF DESCRIPTION OF THE DRAWINGS

FIG. 1 shows the constitution of the circuit of the cordless phone child device of this embodiment;

FIG. 2 is a flowchart in which the channel switching judgment routine is described; and

FIG. 3 is an explanatory view of the channel switching conditions.

### DESCRIPTION OF THE PREFERRED EMBODIMENTS

This embodiment will be described hereinbelow with reference to the drawings.

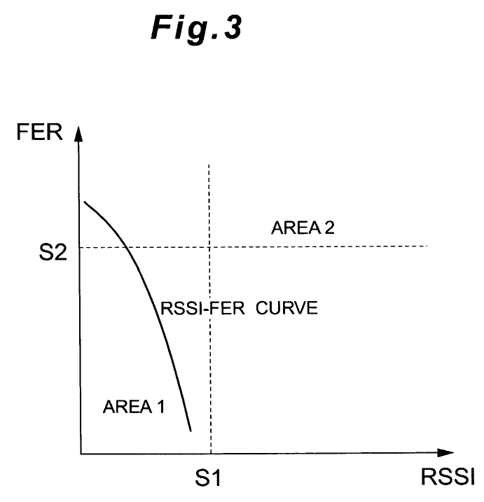

FIG. 3 shows the channel switching conditions of this embodiment. In this figure, the RSSI-FER curve shows the relationship between the FER and RSSI in a wireless environment without interference. The channel switching conditions prescribed by the above-mentioned STD-28 are the locations denoted by area 1 and area 2. Area 1 is independent of FER and prescribes channel switching under the condition that the RSSI should be equal to or less than a threshold value S1. Area 2 prescribes channel switching under the condition that the RSSI should be equal to or more than the threshold value S1 and that the FER be equal to or more than the threshold value S2. In a digital wireless communication system that performs wireless communications via a single base station as in the case of a cordless phone, the following conditions must be fulfilled as channel switching conditions:

(1) Channel switching should not be executed in a weak electric field;

(2) Channel switching should not be executed by phasing;

(3) Channel switching should not be executed with respect to frequency hopping interfering waves.

For this reason, reconnection is difficult when channel switching is performed in a weak electric field. Further, this is because performing channel switching by means of phasing brings about an increase in the unnecessary mute interval, which is unpleasant for the caller. Further, the frequency of a frequency hopping interfering waves varies at very short intervals and the effect on the cordless phone is small. There is therefore no need to perform channel switching because of these interfering waves.

In order to satisfy conditions (1) to (3), channel switching is required in area 2. In order to execute channel switching in area 2, it is necessary to distinguish whether or not the wireless environment is a weak electric field. A suitable distinction must also be made of whether the cause of the frame error is interfering waves or whether the frame error was generated unexpectedly as is true for phasing, frequency hopping, and so forth. The constitution of a digital wireless communication device for performing channel switching in area 2 (a cordless phone child device is illustrated here) will be described in detail hereinbelow.

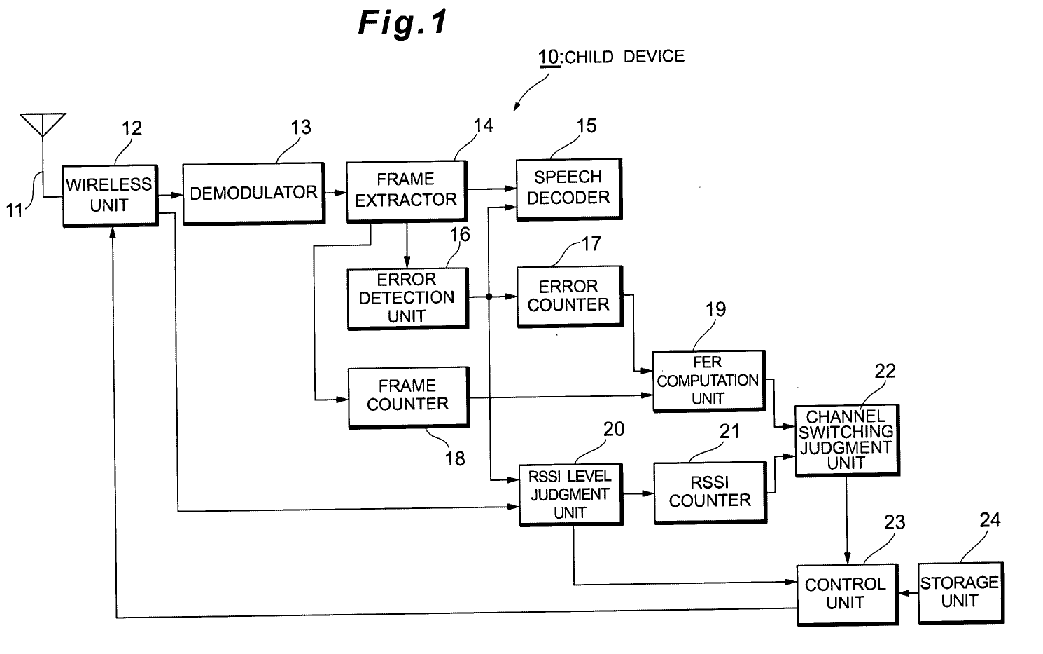

FIG. 1 shows the receiver circuit of a digital cordless phone child device 10 that performs wireless communications with a single parent device (base station). The child device 10 is constituted comprising a speech signal decoding system (an antenna 11, wireless unit 12, demodulator 13, frame extractor 14, and speech decoder 15); a frame error rate computation system (error detection unit 16, error counter 17, frame counter 18, and FER computation unit 19) for computing the frame error rate; a RSSI count system (RSSI level judgment unit 20 and RSSI counter 21) for counting the number of frames for which a frame error is generated with an RSSI at or above a certain fixed level; a channel switching judgment unit 22 that judges channel switching; a control unit 23 that controls channel switching; and a storage unit 24 for sharing channel switching information with a parent device.

After being amplified by the wireless unit 12, the signal received via the antenna 11 is demodulated by the demodulator 13. The demodulated signal undergoes signal processing by the frame extractor 14 and frames are extracted. After being subjected to speech signal processing to raise the acoustic characteristic above the output of the error detection unit 16 that performs frame error detection, the extracted frames are decoded in the speech decoder 15 and outputted as a speech signal. In addition, the frames extracted by means of the frame extractor 14 are checked for the presence of code errors by the error detection unit 16. The error counter 17 counts the code errors when code errors are detected by the error detection unit 16. The frame counter 18 counts the number of frames based on a frame interrupt signal. When the number of received frames reaches a prescribed number (several hundred frames, for example), the FER computation unit 19 computes the frame error rate on the basis of the number of errors counted by the error counter 17.

When a frame error is detected by the error detection unit 16, same outputs an error detection signal to the RSSI level judgment unit 20. The RSSI level judgment unit 20 judges whether the RSSI of the frame in which the frame error was detected is equal to or more than the threshold value S1. The threshold value S1 is desirably set at an RSSI value at which no frame error occurs in a wireless environment in which no interfering waves exist. The RSSI counter 21 counts the number of frames in which a frame error is detected and for which the RSSI exceeds the threshold value S1. It can be concluded that frames for which the RSSI is equal to or more than the threshold value S1 and in which a frame error has been generated are frames in which a frame error has occurred due to the effects of interfering waves. When such frames are continuously detected at fixed intervals linking the frames (frame number NE, for example), it may be considered that the cordless phone does not generate frame errors due to frequency hopping interfering waves or unexpected phasing but instead generates frame errors due to an interference source such as a wireless LAN system or microwave oven, or the like.

When the frame error rate computed by the FER computation unit 19 is equal to or more than a threshold value S2 and the number of frames counted by the RSSI counter 21 is equal to or more than the threshold value NE, the channel switching judgment unit 22 judges that the channel switching conditions have been fulfilled. The threshold value NE is desirably set at a number of frames that is aimed at judging whether the radio interference is caused by phasing, frequency hopping, or the like.

When the channel switching conditions are fulfilled, interfering waves are thought to exist in the wireless environment and hence the control unit 23 controls the wireless unit 12 to execute channel switching.

Information on channels for a new connection at the time of channel switching (channel switching information) is stored in the storage unit 24. Information that is the same as this channel switching information is also stored in the parent device and constituted to allow the child device 10 and parent device to change channels in sync with each other. For example, the channel switching information may be shared via a control channel or the like between the child device 10 and parent device, and the channel switching order may be established beforehand. The control unit 23 selects the channel that is to be connected next on the basis of the channel switching information stored in the storage unit 24 and changes channel with substantially the same timing as the timing at which the parent device changes channel. It is therefore possible to perform muteless channel switching.

Further, where the priority level for the channel switching is concerned, the level is desirably set such that the priority level is higher for call channels in which no interfering waves are present wherever possible. In order to set the call channel priority level in this manner, the RSSI may be measured by allocating call channels that are not used for a connection with the base station as channels for control at fixed intervals and the existence of interfering waves may be checked from the RSSI level, for example. The RSSI of each channel can be measured by the RSSI level judgment unit 20, for example. The RSSI level judgment unit 20 functions as a measurement unit for measuring the RSSI. The result of the RSSI measurement of each channel is output to the control unit 23 by the RSSI level judgment unit 20. The control unit 23 establishes the channel switching priority level from the RSSI measurement result for each call channel that is not used for a connection with the base station, and stores the channel switching priority level in the storage unit 24.

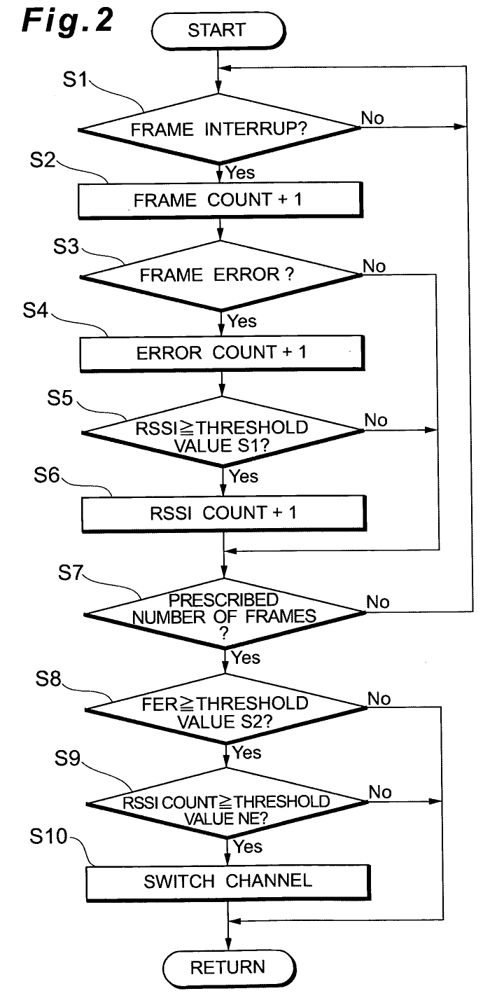

FIG. 2 shows a channel switching judgment routine. When the above channel switching judgment is restated based on this judgment routine, the routine runs as follows. Upon receiving the frame interrupt signal from the frame extractor 14 (step S1; YES), the frame counter 18 increments the frame count number by one (step S2). Then, using the error detection unit 16, a check is made of whether a frame error has been generated (step S3). When a frame error is detected (step S3; YES), the error counter 17 increments the count value by one (step S4). The RSSI level judgment unit 20 checks whether the RSSI level of the frame in which the frame error was detected is equal to or more than the threshold value S1 (step S5). When the RSSI level of the frame in which the frame error was detected is equal to or more than the threshold value S1, the RSSI counter 21 increments the counter value by one (step S6). When a frame error is not detected (step S3; NO) or when the RSSI level of the frame in which the frame error was detected is less than the threshold value S1 (step S5; NO), processing jumps to step S7.

In step S7, a check is made of whether the number of received frames has reached the prescribed number. When the number of received frames has not reached the prescribed number (step S7; NO), steps S1 to S6 are repeated until the prescribed number is reached. If the number of received frames has reached the prescribed number (step S7; YES), a check is made of whether the frame error rate computed on the basis of the count value of the error counter 17 is equal to or more than the threshold value S2 (step S8). If the frame error rate is equal to or more than the threshold value S2 (step S8; YES), a check is made of whether the counter value of the RSSI counter 21 is equal to or more than the threshold value NE (step S9). If the counter value of the RSSI counter 21 is equal to or more than the threshold value NE (step S9; YES), the channel switching judgment unit 22 judges that the channel switching conditions have been fulfilled and the control unit 23 performs channel switching processing (step S10). However, when the frame error rate is less than the threshold value S2 (step S8; NO), or when the counter value of the RSSI counter 21 is less than the threshold value NE (step S9; NO), it is judged that the channel switching conditions are not fulfilled and channel switching processing is not executed.

With this embodiment, when there is a single base station, channel switching is not executed merely because the wireless environment is a weak electric field. Suitable channel switching can be performed by making a distinction as to whether the cause of a frame error generated under the condition that the RSSI should be equal to or more than the threshold value S1 is due to interfering waves or generated unexpectedly as in the case of phasing, frequency hopping, or the like.

This embodiment was described by taking the example of a cordless phone. However, the present invention is not limited to or by a cordless phone, being equally applicable to a cellular terminal, a wireless LAN system or Bluetooth, or the like as long as such as a device is a digital wireless communication device that performs wireless communications with a single base station.

What is claimed is:

1. A digital wireless communication device that performs wireless communications with a single base station and performs channel switching when pre-established channel switching conditions are fulfilled, comprising:
a wireless unit that sends and receives a wireless signal to and from the base station;
a frame extractor that extracts frames from the wireless signal;
a frame error rate computation unit that computes the frame error rate of the frames extracted by the frame extractor;
a counter that counts the number of frames in which a frame error occurs among the frames extracted by the frame extractor and for which the received signal intensity exceeds a predetermined threshold value; and
a channel switching judgment unit that judges that the channel switching conditions have been fulfilled when the frame error rate computed by the frame error rate computation unit is equal to or more than a predetermined threshold value and the number of frames counted by the counter is equal to or more than a predetermined threshold value.

2. The digital wireless communication device according to claim 1, further comprising:
a control unit that, when the channel switching conditions are fulfilled, switches the channel in sync with the base station on the basis of channel switching information that is shared beforehand with the base station.

3. The digital wireless communication device according to claim 2, further comprising:
a measurement unit that measures the received signal intensity in a channel that is not being used for a connection with the base station among a plurality of channels,
wherein the control unit sets reconnection channel priority levels in order starting with the highest priority level for the lowest received signal intensity measured by the measurement unit.
